(19) United States
(12) Patent Application Publication
(10) Pub. No.: US 2025/0338129 A1
(43) Pub. Date: Oct. 30, 2025

(54) ELECTRONIC SYSTEM WITH AUTOMATIC ROLE JUDGEMENT

(71) Applicant: Cheng Wang, Taipei City (TW)

(72) Inventor: Cheng Wang, Taipei City (TW)

(21) Appl. No.: 19/183,914

(22) Filed: Apr. 20, 2025

Related U.S. Application Data
(60) Provisional application No. 63/639,702, filed on Apr. 29, 2024.

(30) Foreign Application Priority Data
Mar. 6, 2025 (TW) 114111528

(51) Int. Cl. H04W 12/50; H04W 12/37

(52) U.S. Cl. CPC H04W 12/50; H04W 12/37

(57) ABSTRACT

An electronic system with automatic role judgement is provided. The electronic system includes a first device and a second device. The first device has the capability to act as a central device and a peripheral device role simultaneously, and is configured to activate an automatic pairing mode and continue to transmit a broadcast packet of the first device. The second device has the capability to act as the central device and the peripheral device role simultaneously, and is configured to activate the automatic pairing mode and continue to transmit a broadcast packet of the second device. The first device is configured to perform an automatic role judgement procedure to determine a central device from the first device and the second device according to the broadcast packets of the first device and the second device. The central device is configured to initiate and perform a pairing and connection operation.

### CROSS REFERENCE TO RELATED APPLICATIONS

This application claims the benefit of U.S. Provisional Application No. 63/639, 702, filed on Apr. 29, 2024. The content of the application is incorporated herein by reference.

### BACKGROUND OF THE INVENTION

### 1. Field of the Invention

The present invention relates to an electronic system, and more particularly, to an electronic system with automatic role judgement function.

### 2. Description of the Prior Art

With development of wireless communication technology, most electronic products can support Bluetooth communication function. Bluetooth low energy (BLE) technology has been widely applied in various electronic products. During the pairing process, the device roles of the BLE device can be divided into a central device and a peripheral device. The central device can be paired with the peripheral devices for communication. However, in existing applications, each device must be set in advance as a central device role or a peripheral device role for pairing and connection. Once the device roles are set in advance, peripheral devices will not be able to pair and connect with each other. Also, the central devices cannot be paired and connected with each other, thus limiting the scalability and extensibility of the electronic device and causing the inconvenience for using. Thus, there is a need for improvement.

### SUMMARY OF THE INVENTION

It is therefore an objective of the present invention to provide an electronic system with automatic role judgement function, to solve the abovementioned problem.

According to an embodiment of the present invention, an electronic system with automatic role judgement is provided. The electronic system with automatic role judgement driving device comprises a first device, having a capability to act as a central device and a peripheral device role simultaneously, and configured to activate an automatic pairing mode and continue to transmit a broadcast packet of the first device; and a second device, having the capability to act as the central device and the peripheral device role simultaneously, and configured to activate the automatic pairing mode and continue to transmit a broadcast packet of the second device; wherein the first device is configured to receive the broadcast packet of the second device and perform an automatic role judgement procedure to determine a central device from the first device and the second device according to the broadcast packet of the first device and the broadcast packet of the second device, and the central device is configured to initiate and perform a pairing and connection operation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flow diagram of a procedure according to an embodiment of the present invention.

FIG. 2 is a schematic diagram illustrating the operation of performing the automatic role judgement procedure for pairing connection according to an embodiment of the present invention.

FIG. 3 is a schematic diagram illustrating the operation status relationship between devices during pairing connection according to an embodiment of the present invention.

FIG. 4 is a schematic diagram illustrating the pairing connection operation between devices according to an embodiment of the present invention.

FIG. 5 is a schematic diagram illustrating the packet processing period of the device according to an embodiment of the present invention.

FIG. 6 is a schematic diagram illustrating packet operations of the device in random time-division manner according to an embodiment of the present invention.

FIG. 7 is a schematic diagram illustrating the operation status relationship between devices during pairing connection according to an alternative embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are utilized in an open-ended fashion, and thus should be interpreted to mean “include, but not limited to . . . ”.

An electronic system of embodiments of the present invention includes a plurality of electronic devices (hereinafter referred to as devices). The device may be equipped with wireless communication capabilities. The number of the devices in the electronic system may be varied and designed according to practical requirements. The device may support Bluetooth Low Energy (BLE) protocol, Bluetooth protocol or other wireless communication protocols to establish a wireless connection for transmitting and receiving data. The device of the embodiments of the present invention can have the capability of acting as a central device (i.e., central role) and the capability of acting as a peripheral device (i.e., peripheral role) simultaneously. With the capability of acting as the central device, the device can operate in the central device role to initiate and establish a pairing connection when establishing communication between the devices. With the capability of acting as the peripheral device, the device can operate in the peripheral device role to cooperate with the central device for pairing connection when establishing communication between the devices. The device of the embodiments of the present invention may have the capability of both acting as the central device and acting as the peripheral device simultaneously. The device of the embodiments of the present invention does not need to preset or pre-define the device role, and a pairing connection can be established through an automatic role judgement procedure of the embodiments of the present invention. For example, the device of the embodiments of the present invention may be a wearable device, a smartphone, a smart watch, a smart bracelet, a smart positioning tag, headphones, a mobile communication device, a tablet, a notebook computers, an embedded system products, a TV, a desktop, but not limited thereto.

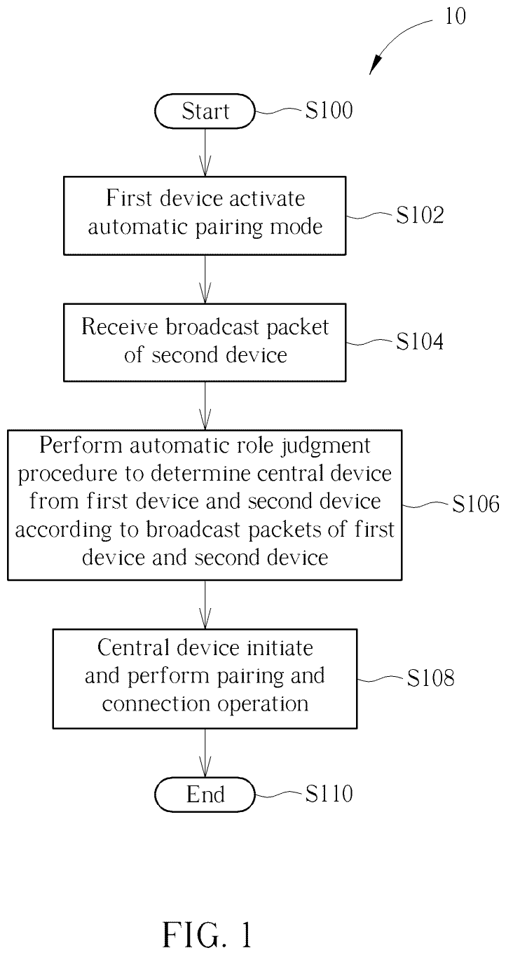

The embodiments of the present invention can be applied in the operation process of performing pairing connection between devices. The embodiments of the present invention can offer devices that have not been assigned or pre-defined any device role to automatically determine device roles and establish pairing connections. Further description associated with the connection method with automatic role judgement for the electronic system, please refer to FIG. 1. FIG. 1 is a flow diagram of a procedure 10 of the connection method with automatic role judgement according to an embodiment of the present invention. The procedure 10 includes the following steps:
Step S100: Start.
Step S102: First device activate automatic pairing mode.
Step S104: Receive broadcast packet of second device.
Step S106: Perform automatic role judgement procedure to determine central device from first device and second device according to broadcast packets of first device and second device.
Step S108: Central device initiate and perform a pairing and connection operation.
Step S110: End.

According to the procedure 10, in Step S102, each device of the electronic system of the embodiments of the present invention may activate an automatic pairing mode for automatic role judgement and transmit broadcast packets (advertising packets). For brevity of description, a first device and a second device are used as examples for illustration in the following description. Each of the first device and the second device may be one of the devices in the electronic system of the embodiments of the present invention. The first device has the capability to act as a central device role and a peripheral device role simultaneously. The second device also has the capability to act as the central device role and the peripheral device role simultaneously. The first device has not been assigned or pre-defined any device role, and the second device has not been assigned or pre-defined any device role either. The first device and the second device may be respectively activated to enter an automatic pairing mode with automatic role judgement based on operations of users.

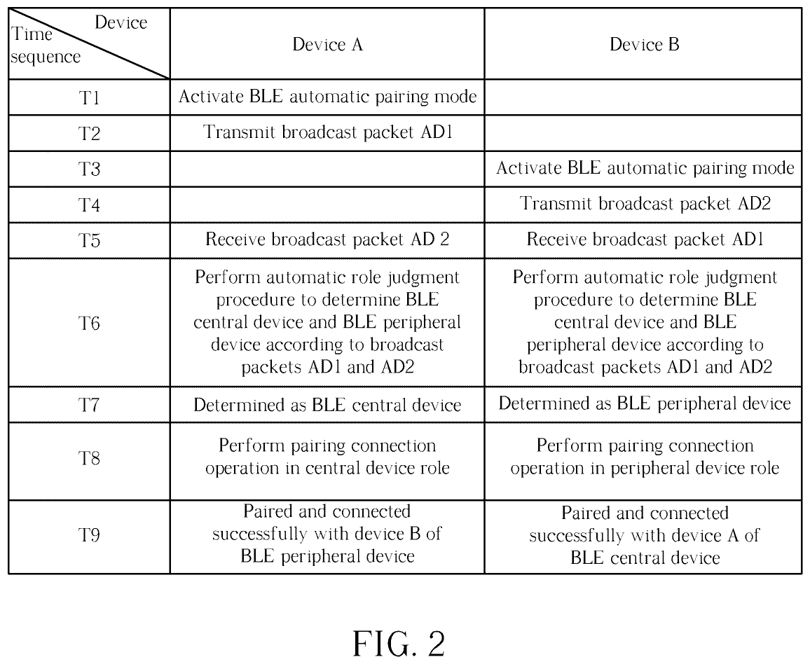

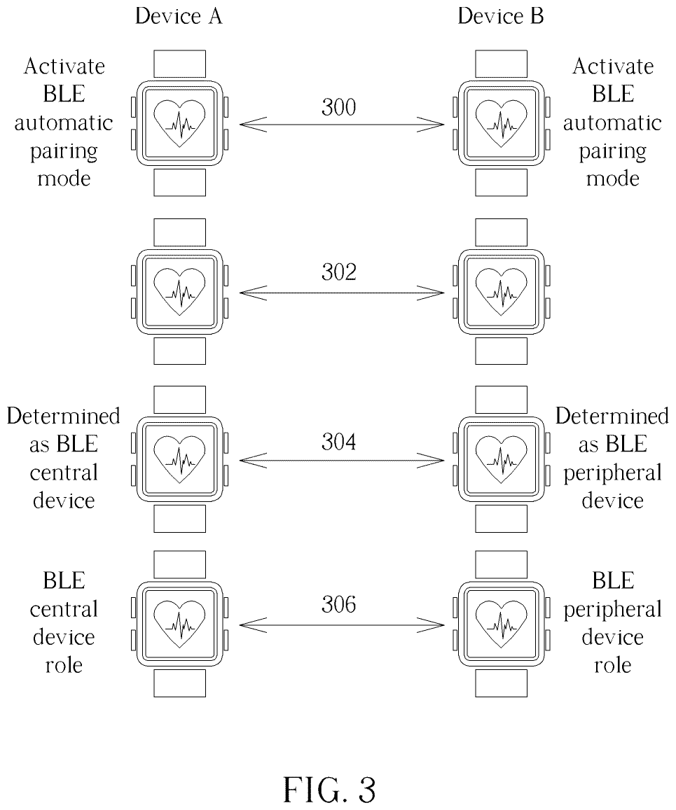

For example, please refer to FIG. 2 and FIG. 3. FIG. 2 is a schematic diagram illustrating operations of performing the automatic role judgement procedure for pairing connection according to an embodiment of the present invention. FIG. 3 is a schematic diagram illustrating the operation status relationship between devices during pairing connection according to an embodiment of the present invention. Take pairing connection between BLE devices for example, the device A and the device B both support the BLE communication protocol. The device A and the device B both have the capability to act as a central device and a peripheral device. As shown in FIG. 2, at time T1, the device A is activated to enter a BLE automatic pairing mode based on an operation (e.g., pressing a specific button for 3 seconds) of a user. At time T3, the device B is activated to enter the BLE automatic pairing mode based on an operation (e.g., pressing a specific button for 3 seconds) of another user. For example, as shown in FIG. 3, at operation state 300, the device A activates and operates in the BLE automatic pairing mode. The device B also activates and operates in the BLE automatic pairing mode.

In the automatic pairing mode, each device may periodically transmit corresponding broadcast packets. The broadcast packet may include proprietary information. The proprietary information in the broadcast packet may include a unique value of the device that is different from other devices. For example, the unique value of the device that is different from other devices may include at least one of a media access control (MAC) address, a product serial number and a random number generated, but not limited thereto. For example, the proprietary information may be encapsulated and written into a manufacturer specific data field of the broadcast packet. The manufacturer specific data field can be used by manufacturers or users to define the meaning of data. For example, the manufacturer specific data field may be a manufacturer specific data field (type 0xFF) for a common data type of an advertising data structure (AD structure) of a BLE advertising packet, but is not limited thereto. As shown in FIG. 2, at time T2, the device A transmits a corresponding broadcast packet AD1 in the BLE automatic pairing mode. The broadcast packet AD1 includes proprietary information associated with the device A. At time T4, the device B transmits a corresponding broadcast packet AD2 in the BLE automatic pairing mode. The broadcast packet AD2 includes proprietary information associated with the device B.

In an embodiment, the broadcast packet includes identification information, and the identification information can be utilized to indicate whether the device has the capability to perform an automatic role judgement procedure. For example, the identification information may be utilized to indicate whether the device has the capability to perform the automatic role judgement procedure of Step S106. For example, the identification information may be encapsulated into a manufacturer-specific data field of a broadcast packet. As shown in FIG. 2, at time T2, the device A has the capability to perform the automatic role judgement procedure and the corresponding identification information can be encapsulated into the broadcast packet AD1 of the device A. The device A may periodically send the broadcast packet AD1. At time T4, the device B has the capability to perform the automatic role judgement procedure and the corresponding identification information can be encapsulated into the broadcast packet AD2 of the device B. The device B may periodically send the broadcast packet AD2.

In Step S104, each device can receive broadcast packets sent by other devices and parse packet contents in the broadcast packets for subsequent automatic role judgement procedure. For example, as shown in FIG. 2, at time T5, the device A may receive the broadcast packet AD2 from the device B. The device B can receive the broadcast packet AD1 from the device A.

In Step S106, the first device may perform an automatic role judgement procedure to determine a central device from the first device and the second device according to the broadcast packet of the first device and the broadcast packet of the second device. For example, the first device may perform the automatic role judgement procedure to select one of the first device and the second device for acting as the central device. Moreover, when the second device is determined to be the central device, the first device may determine that the first device is the peripheral device. When the first device is determined to be the central device, the first device may determine that the second device is the peripheral device. As shown in FIG. 2, at time T6, the device A performs an automatic role judgement procedure according to the broadcast packets AD1 and AD2 to determine a BLE central device and a BLE peripheral device. At time T7, after performing the automatic role judgement procedure, the device A determines that the device A acts as the BLE central device and the device B acts as the BLE peripheral device.

In an embodiment, the first device has the capability of performing the automatic role judgement procedure. The first device may parse the broadcast packet of the second device to obtain the identification information in the broadcast packet and accordingly determine whether the second device has the capability of performing the automatic role judgement procedure. As the identification information in the broadcast packet of the second device indicates that the second device has the capability to perform the automatic role judgement procedure, this means that the first device and the second device both have the capability of performing the automatic role judgement procedure. When entering the automatic pairing mode, both of the first device and the second device may perform an automatic role judgement procedure. Since the automatic role judgement procedures are both performed based on the broadcast packet of the first device and the broadcast packet of the second device, the automatic role judgement procedures performed by the first device or the second device would have the same device role judgement result. As shown in FIG. 2, at time T6, the device A may perform an automatic role judgement procedure to determine the BLE central device and the BLE peripheral device according to the broadcast packets AD1 and AD2. The device B may also perform an automatic role judgement procedure to determine the BLE central device and the BLE peripheral device according to the broadcast packets AD1 and AD2. For example, as shown in FIG. 3, in operation state 302, both the device A and the device B have the capability to perform the automatic role judgement procedure.

Moreover, the first device may perform an automatic role judgement procedure to determine a central device from the first device and the second device according to identification information of the broadcast packets of the first device and the second device. For example, the first device may obtain the proprietary information associated with the first device from a manufacturer specific field in the broadcast packet of the first device. The first device may parse the broadcast packet of the second device to obtain the identification information from a manufacturer specific field in the broadcast packet of the second device. When performing the automatic role judgement procedure, the first device may compare the identification information of the broadcast packet of the first device with the identification information of the broadcast packet of the second device to generate a comparison result. The first device may determine the central device and the peripheral device according to the comparison result.

In an embodiment, the proprietary information of the broadcast packet of the first device includes a unique value VA of the first device that is different from other devices. The proprietary information of the broadcast packet of the second device includes a unique value VB of the second device that is different from other devices. When performing the automatic role judgement procedure, the first device is configured to obtain the unique value VA from the broadcast packet of the first device and obtain the unique value VB from the broadcast packet of the second device. The first device is configured to compare the unique value VA of the first device with the unique value VB of the second device to generate a comparison result, and determine the central device and the peripheral device according to the comparison result. When the comparison result indicates that the unique value VA of the first device is greater than the unique value VB of the second device, the first device is configured to determine the first device for acting as the central device and determine the second device for acting as the peripheral device. When the comparison result indicates that the unique value VB of the second device is greater than the unique value VA of the first device, the first device is configured to determine the second device for acting as the central device and determine the first device for acting as the peripheral device. For example, as shown in FIG. 2 and FIG. 3, at time T7, the device A compares a unique value VA of the device A with a unique value VB of the device B. The comparison result indicates that the unique value VA of the device A is greater than the unique value VB of the device B, the device A is determined as a BLE central device and the device B is determined as a BLE peripheral device.

In the embodiments of the present invention, the unique value of the device that is different from other devices may include a MAC address, a product serial number and a random number generated when activating the automatic role judgement procedure, but not limited thereto.

In an embodiment, the proprietary information may include a packet processing period. The proprietary information of the broadcast packet of the first device includes a packet processing period of the first device, and the packet processing period may be from a mode activation time point that the first device activates the automatic pairing mode to the time point that the broadcast packet of the first device is transmitted. The proprietary information of the broadcast packet of the second device includes a packet processing period of the second device, and the packet processing period may be from a mode activation time point that the second device activates the automatic pairing mode to the time point that the broadcast packet of the second device is transmitted. When performing the automatic role judgement procedure, the first device may obtain respective packet processing periods from the broadcast packet of the first device and the broadcast packet of the second device. The first device may compare the packet processing period of the first device with the packet processing period of the second device to generate a comparison result. As such, the first device may determine the central device and the peripheral device according to the comparison result. When the comparison result indicates that a length of the packet processing period of the first device is greater than a length of the packet processing period of the second device, the first device is configured to determine the first device for acting as the central device and determine the second device for acting as the peripheral device. When the comparison result indicates that a length of the packet processing period of the second device is greater than a length of the packet processing period of the first device, the first device is configured to determine the second device for acting as the central device and determine the first device for acting as the peripheral device.

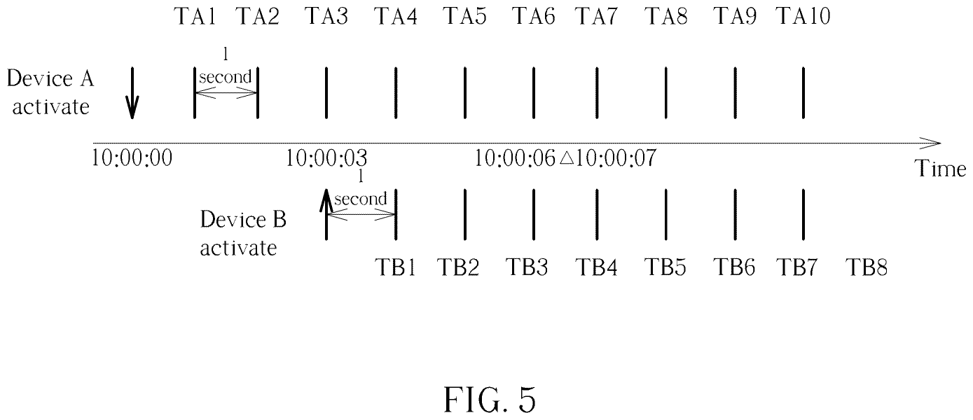

For example, as shown in FIG. 5, the devices A and B periodically (e.g., every 1 second) transmit corresponding broadcast packets. The mode activation time of the device A is 10:00:00, and the mode activation time of the device B is 10:00:03. During time TA6 (10:00:06) to time TA7 (10:00:07), the device A receives the broadcast packet transmitted by the device B at time TB3 (10:00:06). Therefore, the packet processing period of the device A is from the mode activation time of the device A to time TA6 (i.e. from 10:00:00 to 10:00:06, period length is 6 seconds). The packet processing period of the device B is from the mode activation time of the device B to time TA6 (i.e. from 10:00:03 to 10:00:06, period length is 3 seconds). The length (6 seconds) of the packet processing period of the device A is greater than the length (3 seconds) of the packet processing period of the device B, such that the device A can be determined as the BLE central device. Therefore, since the devices periodically transmit corresponding broadcast packets, the device with an earlier mode activation time can be determined as the central device during the automatic role judgement procedure. In this way, the user could set the device role based on the mode activation time without complicated operation.

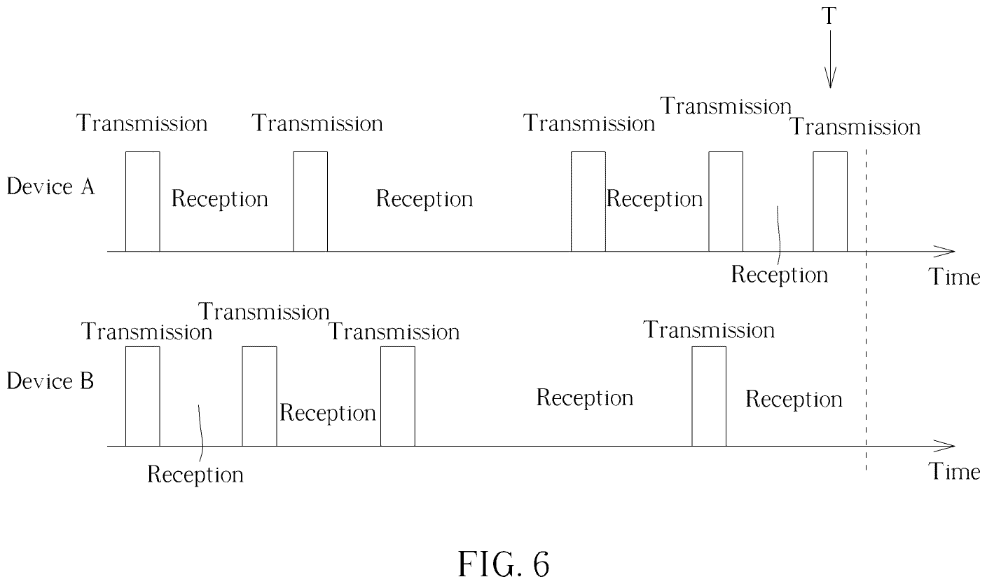

In an embodiment, in Steps S102 and S104, the first device and the second device may operate in a transmission state for transmitting broadcast packets or a reception state for receiving broadcast packets in a random time-division manner. The first device and the second device may be self-preset to be the peripheral device roles and transmit the broadcast packets in the transmission state. The first device may receive the broadcast packet of the second device in the reception state. The second device may receive the broadcast packet of the first device in the reception state. In Step S106, when receiving the broadcast packet from the second device, the first device may immediately determine that the first device is the central device and the second device is the peripheral device during the automatic role judgement procedure. When receiving the broadcast packet from the first device, the second device may immediately determine that the second device is the central device and the first device is the peripheral device during the automatic role judgement procedure. Since the first device and the second device both receive the broadcast packets in the random time-division manner, one of the first device and the second device would certainly receive the broadcast packet first and determine the central device and the peripheral device to initiate the subsequent pairing connection. For example, as shown in FIG. 6, at time T, the device A and the device B enter the BLE automatic pairing mode and perform the automatic role judgement procedure. The device B is in the reception state and receives the broadcast packet of the device A. Under such a situation, the device B immediately determines that device B is the central device and the device A is the peripheral device for performing subsequent pairing and connection operations.

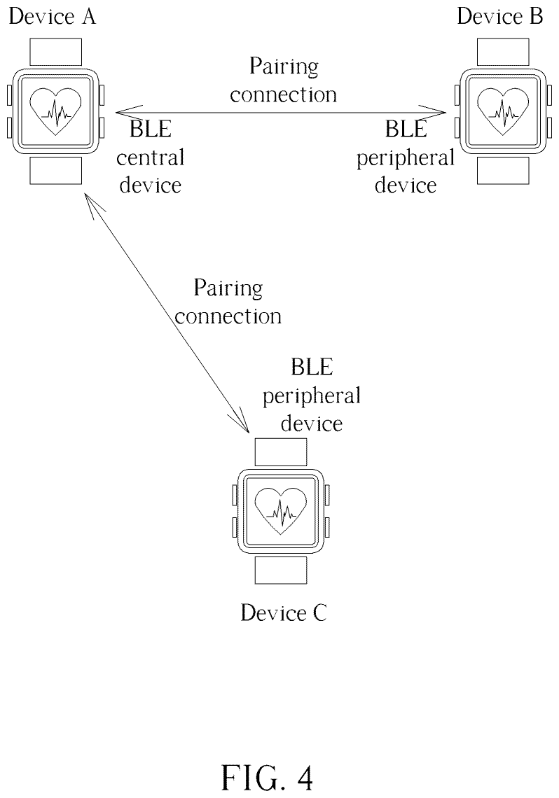

In Step S108, one of the first device and the second device to be determined as the central device can initiate and perform a pairing connection operation. After the device roles are determined in the aforementioned automatic role judgement steps, the device to be determined as the central device role can initiate and establish a connection between the two devices. After the device roles are determined in Step S106, each device may switch to operate in a respective device role state. In an embodiment, when the first device is determined as the central device role and the second device is determined as the peripheral device role, the first device switches to a central device state to perform the central device role, and the second device switches to a peripheral device state to perform the peripheral device role. As such, the first device acting as the central device role can proactively initiate a connection with the second device acting as the peripheral device role. For example, as shown in FIG. 2 and FIG. 4, at time T8, the device A switches to operate in the central device role for performing a pairing connection operation. The device B switches to operate in the peripheral device role for the pairing connection operation. At time T9, the device A and the device B are paired and connecting successfully. For example, as shown in FIG. 3 and FIG. 4, in operation state 306, the device A operates in the BLE central device role, and the device B operates in the BLE peripheral device role. The device A (BLE central device role) initiates and performs a pairing connection operation to establish a connection with the device B. In other words, the devices of the embodiments of the present invention have the capabilities of both the central device and the peripheral device. The embodiments of the present invention can automatically establish a pairing connection by exchanging broadcast packets to perform the automatic role judgement procedure without being pre-defined as a central device or a peripheral device in advance.

On the other hand, in Step S106, when performing the automatic role judgement procedure, the first device may determine whether the second device has the capacity to perform the automatic role judgement procedure. When determining that the second device is incapable of performing the automatic role judgement procedure, the first device may determine the second device for acting as the central device role. In an embodiment, suppose the first device has the capability of performing the automatic role judgement procedure. The second device is an existing device that can only support the device role of a Bluetooth central device without transmitting broadcast packets and is incapable of performing an automatic role judgement procedure. When performing the automatic role judgement procedure in Step S106, the first device does not receive the broadcast packet of the second device and continues to receive a pairing connection request from the second device, such that the first device may determine the second device for acting as the central device incapable of performing the automatic role judgement procedure and also determine the first device for acting as the peripheral device. The embodiments of the present invention can be compatible with existing devices that only support the central device role for automatic pairing and connection.

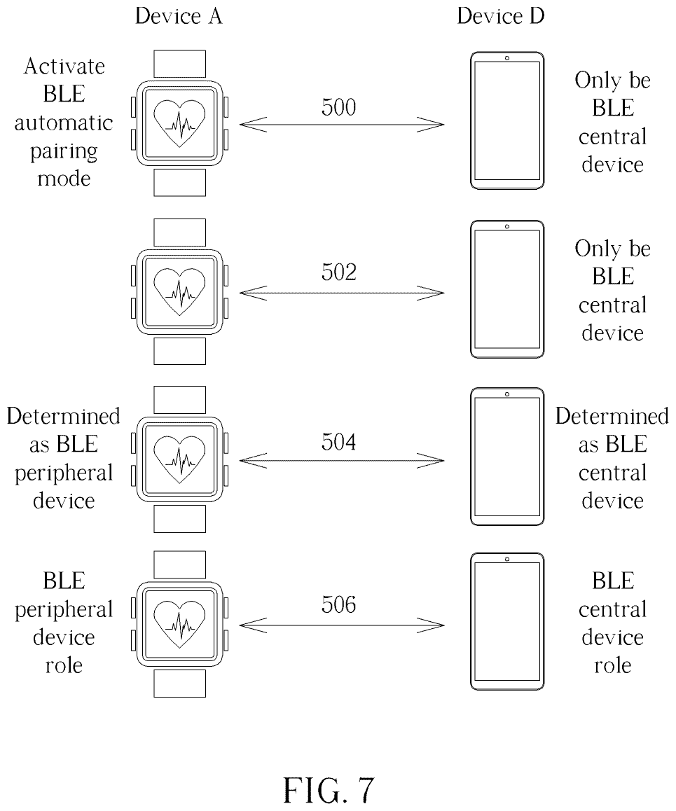

For example, as shown in FIG. 7, suppose the device A has the capability to perform an automatic role judgement procedure. The device D currently only supports the central device role and is incapable of performing the automatic role judgement procedures. In operation state 500, the device A activates the BLE automatic pairing mode while the device D only operates in the central device role. In operation state 502, the device A determines that device D does not have the capability to perform the automatic role judgement procedure. Since the device D is determined to be incapable of performing the automatic role judgement procedure, in operation state 504, the device A determines that the device D is the central device and the device A is the peripheral device. In operation state 506, the device D performs the BLE central device role, and the device A performs the BLE peripheral device role. The device D initiates and performs a pairing and connection operation to establish a connection with the device A.

Please further refer to FIG. 4. In Step S108, after the device A has established a connection with the device B based on the automatic role judgement procedure and on activation of pairing connection operation for the BLE central device role, the device A operates in the BLE central device role and stops performing the automatic role judgement procedure. The device C capable of performing the automatic role judgement procedure activates a BLE automatic pairing mode and determines that the device A has no capability to perform the automatic role judgement procedure. Accordingly, the device C may switch to operate in the peripheral device role, and the device A can initiate a pairing connection based on the BLE central device role to establish a connection with the device C. Therefore, the embodiments of the present invention can be applied in the application environment of multiple devices with automatic role judgement capability.

In addition, the user may also generate a forced role setting through a user interface or a physical object, such that the device may switch to a corresponding device role according to the forced role setting. For example, the user may generate a corresponding forced role setting for the first device by pressing the user interface of the device. Based on the forced role setting, the first device is forcibly switched to act as the central device and stops performing the automatic role judgement procedure. When performing the pairing connection, the second device may determine that the first device is a central device that does not have the capacity to perform the automatic role judgement procedure, and determine that the second device is the peripheral device.

To sum up, the device of the embodiments of the present invention has the capability of acting as the central device and the peripheral device simultaneously. The device of the embodiments of the present invention does not need to preset or pre-define the device role, and a pairing connection can be established through the automatic role judgement procedure of the embodiments of the present invention. Moreover, the embodiments of the present invention can be compatible with existing devices that only support the central device role for automatic pairing and connection. Therefore, the embodiment of the present invention can achieve the purpose of free pairing without being controlled or limited, and significantly enhance the scalability and extensibility of the devices and convenience of use of the devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic system with automatic role judgement, comprising:
a first device, having a capability to act as a central device and a peripheral device role simultaneously, and configured to activate an automatic pairing mode and continue to transmit a broadcast packet of the first device; and
a second device, having the capability to act as the central device and the peripheral device role simultaneously, and configured to activate the automatic pairing mode and continue to transmit a broadcast packet of the second device;
wherein the first device is configured to receive the broadcast packet of the second device and perform an automatic role judgement procedure to determine a central device from the first device and the second device according to the broadcast packet of the first device and the broadcast packet of the second device, and the central device is configured to initiate and perform a pairing and connection operation.

2. The electronic system of claim 1, wherein the first device is configured to compare proprietary information of the broadcast packet of the first device with proprietary information of the broadcast packet of the second device to generate a comparison result, and determine the central device from the first device and the second device according to the comparison result.

3. The electronic system of claim 2, wherein the first device is configured to obtain the proprietary information of the broadcast packet of the second device from a manufacturer specific field in the broadcast packet of the second device.

4. The electronic system of claim 2, wherein the proprietary information of the broadcast packet of the first device comprises a value of the first device being different from other devices, the proprietary information of the broadcast packet of the second device comprises a value of the second device being different from other devices, wherein the first device is configured to compare the value of the first device being different from other devices with the value of the second device being different from other devices when performing the automatic role judgement procedure, the first device is configured to determine the first device for acting as the central device and determine the second device for acting as a peripheral device based on determining that the value of the first device being different from other devices is greater than the value of the second device being different from other devices, and the first device is configured to determine the second device for acting as the central device and determine the first device for acting as the peripheral device based on determining that the value of the second device being different from other devices is greater than the value of the first device being different from other devices.

5. The electronic system of claim 4, wherein the value being different from other devices comprises a media access control (MAC) address, a product serial number or a random number generated when activating the automatic role judgement procedure.

6. The electronic system of claim 2, wherein the proprietary information of the broadcast packet of the first device comprises a packet processing period of the first device, the proprietary information of the broadcast packet of the second device comprises a packet processing period of the second device, wherein the first device is configured to compare the packet processing period of the first device with the packet processing period of the second device when performing the automatic role judgement procedure, the first device is configured to determine the first device for acting as the central device and determine the second device for acting as a peripheral device based on determining that a length of the packet processing period of the first device is greater than a length of the packet processing period of the second device, and the first device is configured to determine the second device for acting as the central device and determine the first device for acting as the peripheral device based on determining that the length of the packet processing period of the second device is greater than the length of the packet processing period of the first device.

7. The electronic system of claim 1, wherein the first device is configured to receive the broadcast packet of the second device in a random time-division manner, and during performing the automatic role judgement procedure, the first device is configured to determine the first device for acting as the central device and determine the second device for acting as a peripheral device while receiving the broadcast packet of the second device.

8. The electronic system of claim 1, wherein when the first device does not receive the broadcast packet of the second device and continues to receive a pairing connection request from the second device, the first device is configured to determine the second device for acting as the central device incapable of performing the automatic role judgement procedure and determine the first device for acting as a peripheral device.

9. The electronic system of claim 1, wherein the first device is forced to be the central device through a user interface and stops performing the automatic role judgement procedure, and the second device is configured to determine the first device for acting as the central device without the capability to perform the automatic role judgement procedure and determine the second device for acting as a peripheral device.
